(19) United States
(12) Patent Application Publication
(10) Pub. No.: US 2003/0179746 A1
(43) Pub. Date: Sep. 25, 2003

(54) Service system for electric home appliances and method thereof

(76) Inventors: Gyeong Ho Moon, Kyongsangnam-do (KR); Sang Su Lee, Kyongsangnam-do (KR)

Correspondence Address: Song K Jung, Mckenna Long & Aldridge, Attorneys at Law, 1900 K Street NW, Washington, DC, 20006, US

(21) Appl. No.: 10/362,741

(22) PCT Filed: Jul. 4, 2002
(86) PCT No.: PCT/KR02/01266

(30) Foreign Application Priority Data
Jul. 4, 2001 (KR) 200139809
Jul. 4, 2001 (KR) 200139810

(51) Int. Cl. H04L 12/66

(52) U.S. Cl. 370/352

(57) ABSTRACT

Disclosed is an on-line system and service method thereof using an on-line linked Internet washer as a medium so as to enable a communication between a client at a remote place and the other client at home using various home appliances installed in each home. The present invention includes a first step of requesting a selection of a target home appliance for message transmission and a second step of transmitting a transmission message to the selected target home appliance.

### TECHNICAL FIELD

The present invention relates to an on-line system and service method thereof using an on-line linked Internet washer as a medium so as to enable a communication between a client at a remote place and the other client at home using various home appliances installed in each home.

### BACKGROUND ART

Currently, every family enjoys convenient life style using a variety of home appliances.

For instance, an automated washer enables to prevent a client from wasting labor and time unnecessarily, a refrigerator enables to keep various kinds of food in store safely, and a microwave range enables to prepare food conveniently.

Specifically, the latest home appliances linked to Internet environments such as the Internet washer and the like show up in the market gradually. Hence, there is no restriction of time and space for washing the laundry since the entire operational control of the Internet washer, if necessary, can be made remotely.

Yet, the above-mentioned Internet washer provides a control service for a simple remote laundry only, but is unable to provide a variety of services using the Internet washer so as to fail to win a customer's favor.

### DISCLOSURE OF THE INVENTION

Accordingly, the present invention is directed to a service system and a service method using the same that substantially obviate one or more of the problems due to limitations and disadvantages of the related art.

An object of the present invention is to provide a service system and a service method using the same so as to enable a communication between a client at a remote place and the other client at home using an on-line linked Internet washer.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a service system according to the present invention includes a home appliance having a network interface for being connected on-line and a message reporting means for reporting messages received from one or more registered remote clients through the network interface, a service server network connected to the network interface so as to transmit a message transmitted from each registered remote client to the home appliance, and a database server communicating with the service server network and having a database, in which registration information of each registered remote client for the home appliances is stored.

To further achieve these and other advantages and in accordance with the purpose of the present invention, a service method of transmitting a message in a service system includes a first step of requesting a selection of a target home appliance for message transmission and a second step of transmitting a transmission message to the selected target home appliance.

To further achieve these and other advantages and in accordance with the purpose of the present invention, an Internet washer includes a network interface connected to a service server network built on-line so as to transmit/receive various data, a message reporting means for reporting a client's operation status and a remote client's message received through the network interface, an operation unit on which various operations are carried out by the client, and a control unit controlling the respective components to operate.

To further achieve these and other advantages and in accordance with the purpose of the present invention, a service method of a message transmission of an Internet washer includes a first step of checking whether a short message data is received from a service server network or not and a second step of decoding a corresponding data, if reception of the short message data is made, so as to report the reception of a message to a corresponding client through a message reporting means.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates schematically a block diagram of a service system according to the present invention;

FIG. 2 illustrates a flowchart of operating procedures of a service system according to the present invention;

FIGS. 3A to FIGS. 3d illustrate status diagrams of screen of a remote client's terminal when a service is being provided;

FIG. 4 illustrates a flowchart of setting up a method of displaying a message when a service according to the present invention is being provided;

FIG. 5 illustrates a flowchart for representing a control status of each home appliance when a service according to the present invention is being provided; and

FIG. 6 and FIG. 7 illustrate flowcharts of other embodiments of a service for message transmission.

### BEST MODE FOR CARRYING OUT THE INVENTION

Reference will now be made in detail to the preferred embodiments of the present invention, examples of which are illustrated in the accompanying drawings.

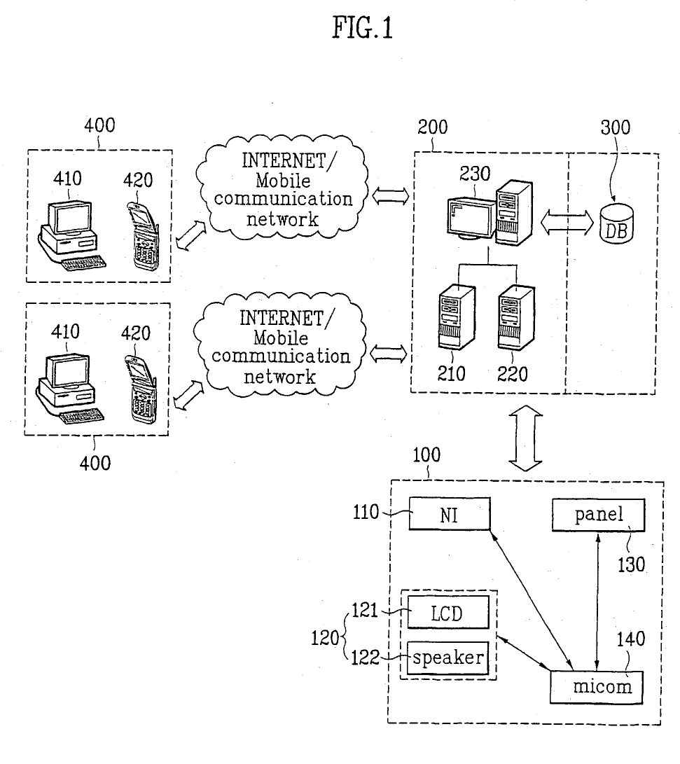

Preferred embodiments of the present invention are explained in detail by referring to FIGS. 1 to FIGS. 7.

First of all, FIG. 1 illustrates schematically a messaging service system using a home appliance according to the present invention.

Namely, a service system according to the present invention mainly includes a home appliance 100, a service server network 200, and a database server 300.

The home appliance 100 constituting the service system includes a network interface 110 for on-line connection, a message reporting means 120 for reporting a message, an operation unit 130, and a control unit 140, and is an Internet washer as an example.

Of course, for the embodiment of the present invention, the home appliance can be any one of various appliances enabling to be connected to an Internet environment such as an Internet refrigerator, an Internet microwave range, and Internet air conditioner, and the like.

In this case, the network interface 110 is linked to the service server network 200 built on-line so as to transmit/receive various data.

Such a network interface 110 is constituted with a data communication network interface card(NIC) enabling data communication for wire/wireless data communication.

Of course, the network interface 110 can be constituted only with a port for data communication such as RS-232C. In this case, each of the home appliances is preferably built to interoperate with a home automation system.

Moreover, the message repot means 120 plays a role in notifying a client's operation status and a remote client's message received through the network interface 110, and includes a display unit 121 such as LCD and a speaker unit 122 outputting sound.

Besides, the operation unit 130 can be a general control panel as a component on which various operations are carried out by the client.

Moreover, the control unit 140 can be a controller controlling operations of the respective components constituting the Internet washer.

And, the service server network(hereinafter called “service server”) 200 constituting the service system of the present invention is built on-line so as to carry out a function of transmitting the message received from each of the remote clients to the Internet washer.

In this case, the service server 200 is built respective in a Web-page for providing services on Web and a Wab-page for providing services in a mobile communication network.

The service server 200 mainly includes a remote control server 210, a short message service server 220, and a control server 230.

The remote control server is a server network enabling to control each operation control of the Internet washer at a remote place.

Moreover, the short message service(SMS) server 220 carries out a function of transferring a message transmitted from each client from at least one on-line network of the Internet network and the mobile communication network to each of the home appliances.

Moreover, the control server 230 is a server built for carrying out a function of an interface communicating with the respective clients' terminals 400 linked on-line as well as a function of controlling each server and processing each demanded command.

The service server 200 is most preferably built by a server managed by a manufacture company of the corresponding home appliance, which is because the manufacture company performs a remote control of the corresponding home appliance with ease as well as facilitates to build a database for the corresponding home appliance.

And, the database server 300 constituting the service system according to the present invention is installed so as to be interconnected to the service server 200, and communicates with the service server 200 so as to register each user's information and information of a home appliance owned by each user.

In this case, each user's information can be identification, password, and the like of each user.

Moreover, the information of the home appliance may include particulars of the home appliances owned by each user, IP(Internet protocol) of each home appliance, each remote controllable function, and the like.

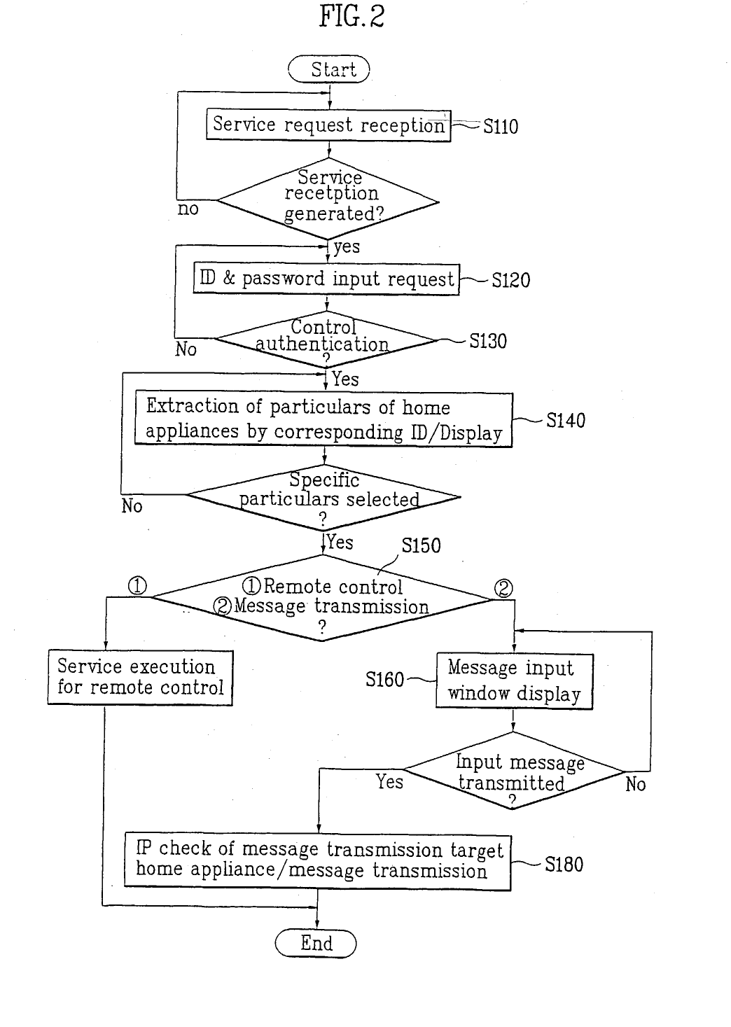

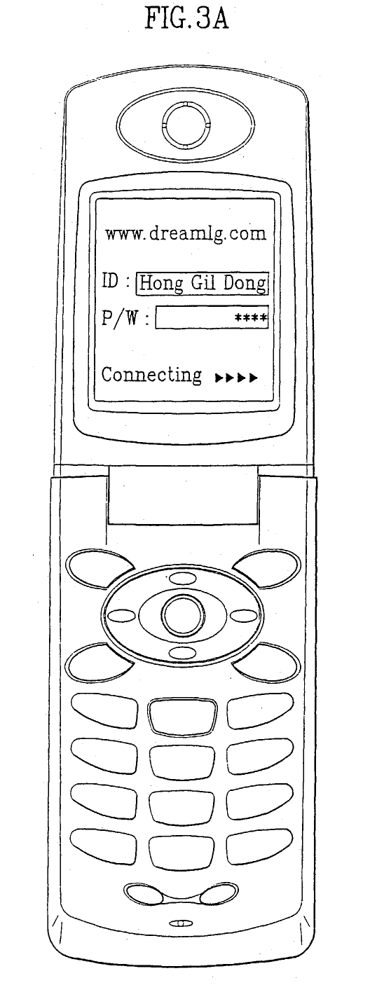

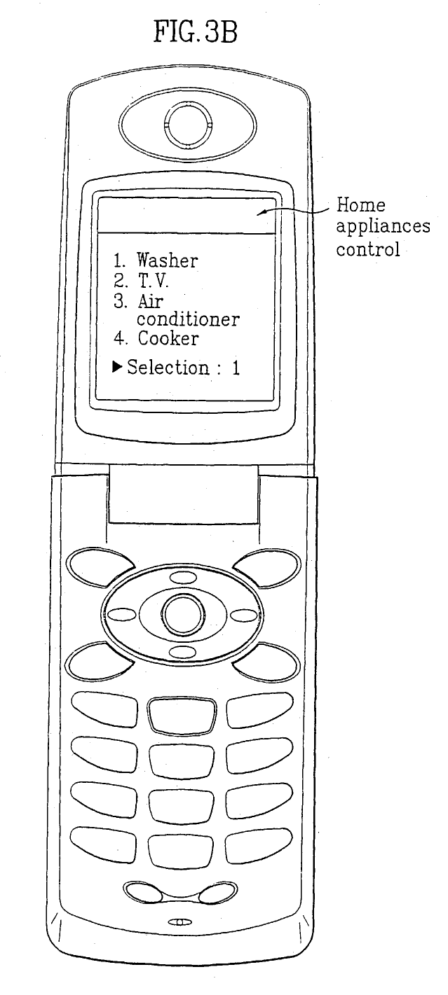

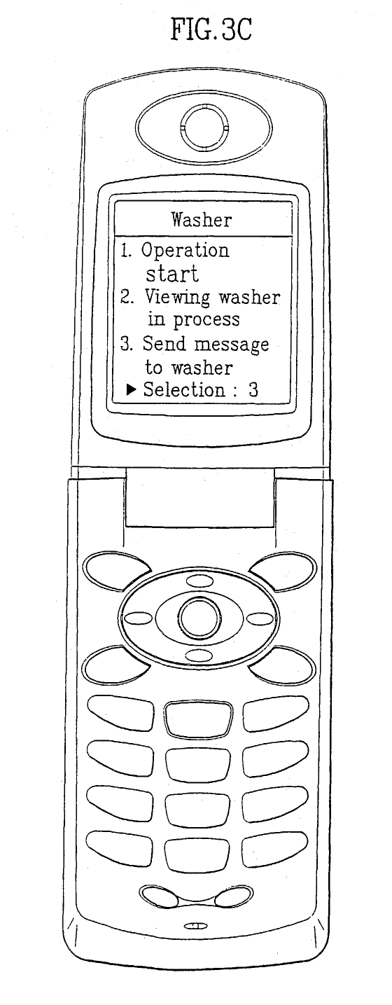

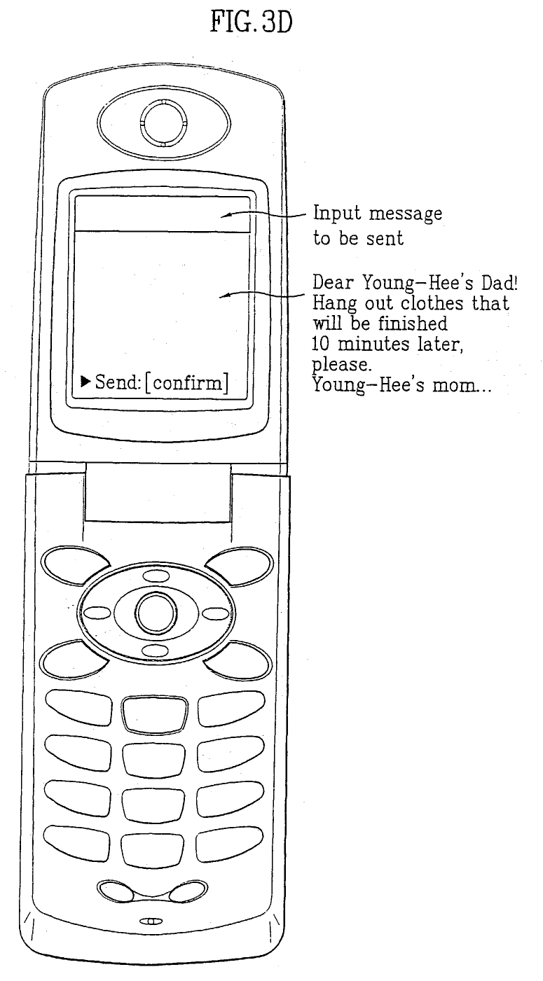

A service method using the above-described constitution according to the present invention is explained in detail in the following description by referring to flowcharts in FIGS. 2 to FIGS. 5 and status diagrams in FIGS. 3A to FIGS. 3D.

First of all, the service server 200, as shown in a flowchart in FIG. 2, receives a demand for various services from each remote client(S110).

This is possible since the service server 200 is built to provide services through the Internet network or mobile communication network in a manner that a Web-site having the Web-page and a Wab-site having the Wab-page are built therein.

Namely, services through the Web-site are provided in case that each client wants to be provided with services using a personal computer(PC) 410 at a remote place. And, services through the Wab-site are provided in case that each client wants to be provided with services using a mobile communication terminal 420 at a remote place.

If a specific client links to the Wab-site through the mobile communication network using the mobile communication terminal 420, the service server 200, as shown in FIG. 3A, performs a control approval of the corresponding client.

Namely, it is requested that identification and password of the corresponding client are inputted thereto (S120)

In this case, when the input of the identification and password responding to the request is made, the service server 200 compares them to a previously registered identification in the database server 300 and a corresponding password so as to perform the control approval(S130).

If the control approval is made through the above process, the service server 200 extracts particulars of the respective home appliances 100 owned by the client of the corresponding identification from the database server 300 so as to display the extracted particulars through the Wab-page(S140).

This status is shown in FIG. 3B.

And, if the corresponding client selects a specific home appliance(ex. washer) 100, the service server 200 communicates with the database server 300 so as to display remote control particulars for the corresponding washer and selection particulars for performing a message transmission service to the corresponding home appliance on the Wab-page(S150). This status is shown in FIG. 3C.

If the client wants execution of the message transmission service, the service server 200, as shown in FIG. 3D, requests an input of a transmission message (S160).

This is performed by displaying a message input window for the message input on the corresponding Wab-page.

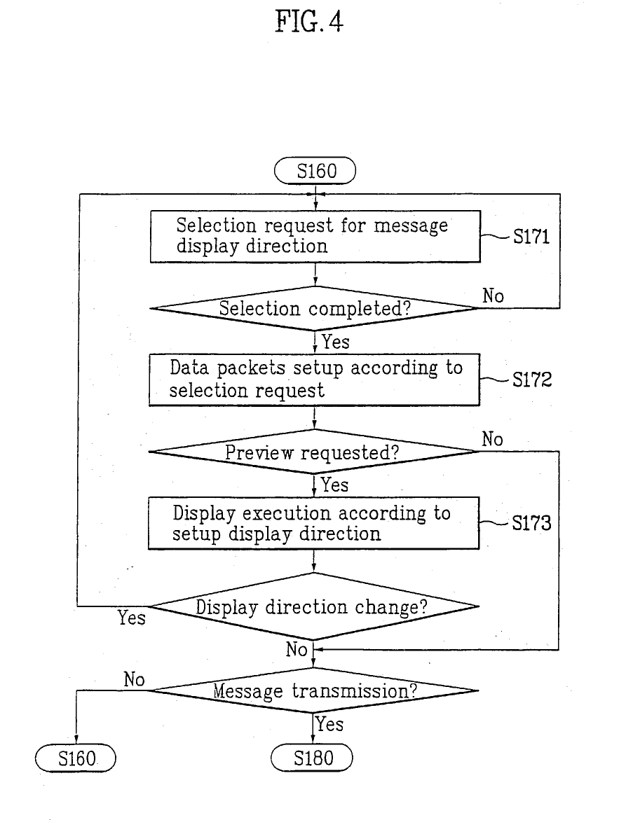

And, after the message input is completed by the above process, the service server, as shown in a flowchart in FIG. 4, requests to select a display method of the message to be transmitted(S171).

For instance, it is requested that a display direction of a message is selected like left to right, right to left, top to bottom, bottom to top, or the like.

Of course, as shown in a flowchart in FIG. 2, the transmission of the message can be performed without the selection of the display method.

In this case, it is proposed that the display method is the display direction of the respective characters constructing the message.

Once the selection of a specific item is made in accordance with the selection request, the service server 200 sets up data packets of the corresponding message so as to realize the display in accordance with the selected display direction(S172).

If the corresponding client selects the display direction of the message to be displayed as left to right, it is possible to be understood that the characters and paragraph of the message are displayed successively from a left side.

Such a service provides versatile display statuses so as to improve satisfaction thereof.

Specifically, the service of present invention further provides ‘a preview function’ enabling to check a display status of the message during the above process.

This is performed in a manner that the message inputted by the client is demonstrated through the terminal of the corresponding client in accordance with the display direction selected by the client.(S173).

Of course, the ‘preview function’ can be skipped in accordance with a client's demand.

If a change of the display direction occurs using the ‘preview function’, a process of requesting to select the display direction of the message is performed again.

Therefore, the client inputs a message to be transmitted to the displayed message input window, and then selects transmission so as to end a series of processes performed by the client for the message transmission.

And, when the message transmission is performed by the above processes, the service server 200 searches the database server 300 so as to check identification of the Internet washer 100 as a message transmission target, and then controls the short message service server so as to transmit the corresponding message to the checked IP(S180).

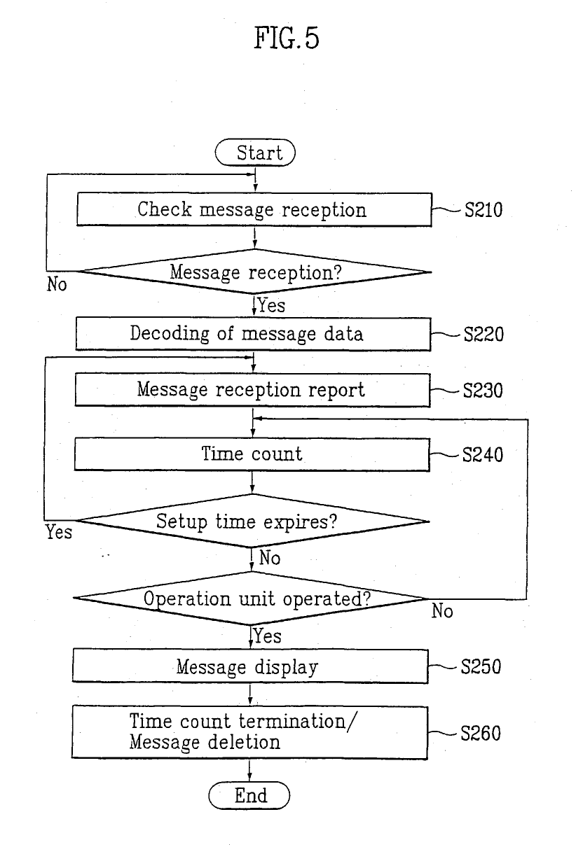

Meanwhile, the Internet washer is controlled on the basis of a process according to a flowchart in FIG. 5 while a series of the above-described processes are performed.

Namely, the control unit 140 checks continuously whether the short message data are received through the network Interface(S210).

If the short message is received, the control unit 140 decodes the corresponding data(S220).

Thereafter, the control unit 140 reports that the reception of the message to a corresponding home client through the message reporting means 120(S230).

In this case, the report is performed in a manner that the corresponding message is displayed on the display unit 121 the moment a buzzer sound or the like is outputted through the sound output unit 122.

In this case, the control unit keeps interpreting whether the client checks the reported message or not.

This is possible made by checking whether an operation of the client through the operation unit 130 is carried out.

Moreover, the control unit 140 counts a time after having performed a report for the message reception.(S240).

This is to report again if there is no check by the client for a predetermined time.

Namely, if the operation of the operation unit 130 fails to be made within a setup time, the report of the message reception is executed repeatedly using the sound output unit 122 after lapse of the setup time.

If it is interpreted that the message check of the client is made by the operation of the operation unit 130, the control unit 140 checks the direction for the display of the message from the corresponding data packet so as to execute the display in accordance with the requested message (S250).

Simultaneously, the control unit 140 makes the display 120, which constitutes the message reporting means 120, return to its original status and stops counting a time.

In this case, the display unit 121 displays a screen for operation control so as to return to the original status and deletes the received data from a corresponding memory(S260).

Therefore, the message reception is available continuously.

Meanwhile, the present invention is not limited to the service performed through a series of the above-described processes only.

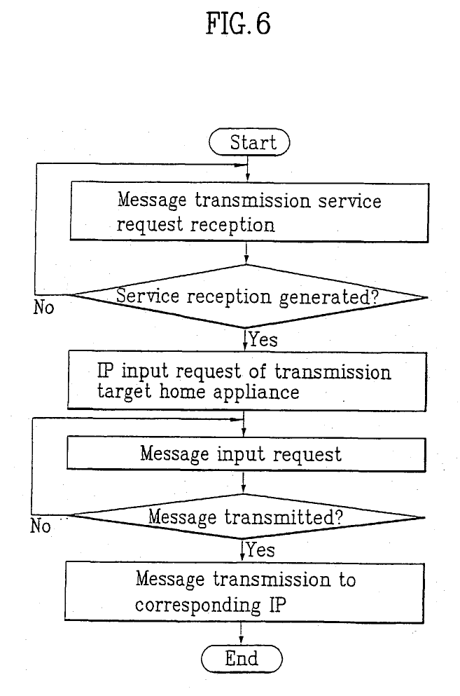

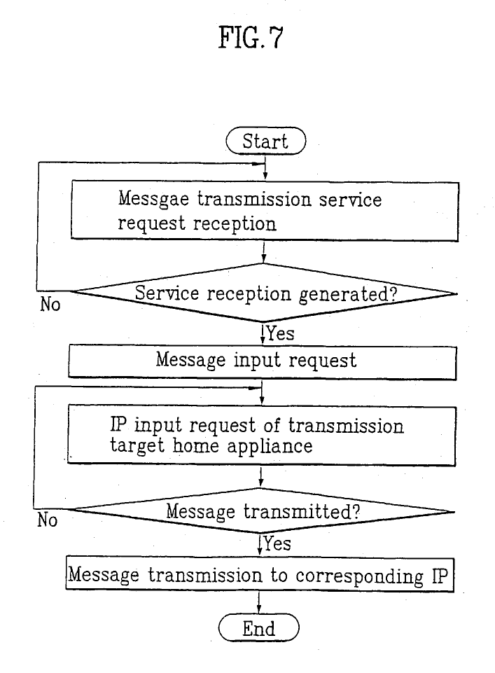

Namely, if the remote client recognizes the IP for the respective home appliances of the corresponding home, as shown in flowcharts in FIG. 6 and FIG. 7, the service for message transmission is just selected by linking to the Web-site or Wab-site operated by the service server 200.

Therefore, without an additional authentication procedure, the transmission message is inputted together with the corresponding IP so as to be transmitted.

In this case, it is able to set up that the input of the transmission message is made after the input of the IP of a transmission target home appliance, as shown in a flowchart of FIG. 6. And, it is also able to set up that the IP input of the transmission target home appliance is made after the input of the transmission message, a shown in a flowchart of FIG. 7.

Moreover, it is possible to provide a selection function in accordance with the display direction.

### Industrial Applicability

Accordingly, the service system and method thereof according to the present invention enable a client at a remote place to provide the other client staying at home with a message through the home appliances, thereby enhancing various functions of each home appliance.

Moreover, the service system and method thereof according to the present invention enable the client staying at home to be informed correctly of the message transmitted through the home appliances, thereby enabling to improve a reliance for the services.

Therefore, the present invention is greatly useful for industry.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

claimed is:

1. A service system comprising:
a home appliance having a network interface for being connected on-line and message reporting means for reporting messages received from one or more registered remote clients through the network interface;
a service server network connected to the network interface so as to transmit a message transmitted from each registered remote client to the home appliance; and
a database server communicating with the service server network and having a database, in which registration information of each registered remote client for the home appliances is stored.

2. The service system of claim 1, wherein the message reporting means of the home appliance comprises at least one of a display unit and a speaker unit outputting sound.

3. The service system of claim 1, wherein the network interface of the home appliance is a data communication network interface card(NIC) for wire/wireless data communication.

4. The service system of claim 1, wherein the network interface of the home appliance is a RS-232C interface.

5. The service system of claim 1, wherein the service server network includes a remote control server being able to control the home appliance and a short message service server transferring a message transmitted from each registered remote client to the home appliance through Internet and mobile communication networks.

6. The service system of claim 1, wherein the service server network is a short message service server transferring a message transmitted from each registered remote client to the home appliance through Internet and mobile communication networks.

7. The service system of claim 1, wherein the home appliance is built to interoperate with a home automation system.

8. A service method of transmitting a message in a service system, comprising:
a first step of requesting a selection of a target home appliance for a message transmission; and
a second step of transmitting a transmission message to the selected target home appliance.

9. The service method of claim 8, further comprising a step of requesting an input of the transmission message before performing the first step.

10. The service method of claim 8, further comprising a step of requesting an input of the transmission message if the selection of the target home appliance is completed after performing the first step.

11. The service method of claim 9 or claim 10, wherein the input of the transmission message is requested in a manner that a specific screen for the input of the message is displayed on a terminal of a corresponding client.

12. The service method of claim 9 or claim 10, further comprising a step of requesting a selection of a display method of the corresponding message when the input of the transmission message is completed.

13. The service method of claim 12, wherein the selection of the display method is a selection for a display direction of characters constructing the message.

14. The service method of claim 8, further comprising a step of having the home appliance report a message reception to a home client by message reporting means.

15. The service method of claim 14, wherein message reception particulars are reported to the home client in a manner that a buzzer sound is outputted by controlling a sound output unit.

16. The service method of claim 8, the first step comprising the steps of:
requesting to input an identification of a message transmitter;
performing a control authentication for the inputted identification;
extracting particulars of home appliances owned by the control-authenticated identification by linking to a database server and displaying the extracted particulars; and
when particulars selection for one of home appliances in the displayed particulars is made, displaying selection particulars for performing a message transmission service to the corresponding home appliance together with remote control particulars of the corresponding home appliance.

17. The service method of claim 16, the step of performing the control authentication for the inputted identification, comprising the steps of:
having an authentication password for the corresponding identification be inputted thereto; and
checking whether the inputted authentication password coincides with a corresponding authentication password registered in the database server for the corresponding identification.

18. The service method of claim 8, wherein the second step is carried out using a short message server included in a service server network.

19. The service method of claim 8, the second step comprising the steps of:
checking an IP of the target home appliance; and
transmitting the corresponding message to the checked IP.

20. An Internet washer comprising:
a network interface connected to a service server network built on-line so as to transmit/receive various data;
a message reporting means for reporting a client's operation status and a remote client's message received through the network interface;
an operation unit on which various operations are carried out by the client; and
a control unit controlling the respective components to operate.

21. A service method of a message transmission of an Internet washer, comprising:
a first step of checking whether a short message data is received from a service server network or not; and
a second step of decoding a corresponding data, if reception of the short message data is made, so as to report the reception of a message to a corresponding client through a message reporting means.

22. The service method of claim 21, further comprising the steps of:
counting a time after completion of the second step; and
reporting again the reception of the message after lapse of a setup time if an input of a confirmation signal fails to be made by the corresponding client within the setup time,
wherein the counting and reporting steps are carried out repeatedly.

23. The service method of claim 22, further comprising a step of restoring a display unit constituting the corresponding message reporting means to an initial status if the input of the confirmation signal is made by the corresponding client within the setup time.

24. The service method of claim 23, further comprising a step of deleting the corresponding message data when the display unit returns to the initial status.

25. The service method of claim 21, wherein the reception of the message is reported to the corresponding client in a manner that the corresponding message is displayed on a display unit and a buzzer sound is outputted through a sound output unit.
